(19) United States
(12) Patent Application Publication
(10) Pub. No.: US 2005/0036599 A1
(43) Pub. Date: Feb. 17, 2005

(54) Telecommunication system and telecommunication device for application therein

(75) Inventor: Robert Willem Van Der Valk, Schoten (BE)

Correspondence Address: BANNER & WITCOFF, 1001 G STREET N W, SUITE 1100, WASHINGTON, DC, 20001, US

(73) Assignee: Chiptec International N.V., Curacao (AN)

(21) Appl. No.: 10/495,168

(22) PCT Filed: Nov. 14, 2001
(86) PCT No.: PCT/NL01/00825

(51) Int. Cl. H04M 15/00

(52) U.S. Cl. 379/114.12

(57) ABSTRACT

A telecommunication system comprises a telecommunication network (10, 20) with a number of optionally permanent connections for subscribers who are connected to the network via an optionally permanent telecommunication connection (12). A subscriber herein has access to at least one telecommunication service in the network (10, 20) by means of a telecommunication device (11) coupled to a connection. The telecommunication device is moreover able to establish a connection with a loyalty server (21) which is coupled to the network and which is able to manage a data file (229. A points total per subscriber is at least temporarily recorded in the data file. Communication means (11, 23, 24) are provided to send the points total to the telecommunication device (11) of a subscriber.

Telecommunication system and telecommunication device for application therein The present invention relates to a telecommunication system comprising a telecommunication network with a number of optionally permanent connections for subscribers who are connected to the network via an optionally permanent telecommunication connection, wherein a subscriber has access to at least one telecommunication service by means of a telecommunication device coupled to a connection.

So-called loyalty programs are an instrument which has become almost indispensable in contemporary marketing and sales, particularly in respect of consumer products and services. The systems employed here still include in many cases relatively outdated saving systems using optionally personalized trading stamp cards on which points, rubber stamps or adhesive stamps are saved and which, when redeemed, give entitlement to a sum of money, optionally in the form of a discount, or to gift items, with or without extra payment. These trading stamp cards are issued by individual retailers, chain stores, shopping centres or by sector umbrella organizations. Particularly in this latter category, electronically readable cards have become more and more popular in recent years because of the advantages inherent thereto. This is always a personalized card with which the purchasing behaviour of the user is recorded precisely by electronic means while he/she saves his/her loyalty points thereon. This purchasing behaviour opens the way to targeted advertizing and marketing with an anticipated increased effectiveness.

Whether the cards are of the old-fashioned type or the modern electronic equivalent thereof, both have the drawback that the user must sign up to the program in advance and the loyalty program can be applied solely to this group of users. Furthermore, a selection of users is thus not possible beforehand, and categories of users will only take shape subsequently.

It is one of the objects of the present invention to provide a telecommunication system of the type stated in the preamble with which a loyalty program can be executed which obviates the above mentioned shortcomings.

For this purpose a telecommunication system of the type stated in the preamble has the feature according to the invention that the telecommunication device is moreover able to establish a connection with a loyalty server which is coupled to the network and which is able to manage a data file in which a points total per subscriber is at least temporarily recorded, and that communication means are provided to send the points total to the telecommunication device of a subscriber. In this respect a loyalty server is understood to mean a processing unit or system of processing units coupled to the network with access to all or distributed storage means which, loaded with suitable software, is able to execute and manage at least a part of a loyalty program assigned thereto.

The telecommunication device can be made available to the subscribers or are acquired by them for the purpose of obtaining the telecommunication service. The personal data of the subscribers are at that moment known by the server. The system then provides the possibility of deciding, on the basis of autonomous criteria, to which subscriber a determined loyalty program will be offered and to which subscriber it will not be offered. A conceivable embodiment is for instance one wherein the subscribers are tenants associated with one or more housing associations which support the system. These housing associations provide all associated tenants with a telecommunication device for connection to the network. In accordance with the tenant behaviour, and in particular whether or not rent is paid on time, loyalty points are then credited to the ‘good’ tenants, which will motivate them to continue their good behaviour. This latter is of direct benefit to the housing associations. The tenants in question likewise benefit in the form of the loyalty points which can be exchanged at optionally specific redemption points for goods, services or optionally even hard cash. In addition, the loyalty server builds up an address database of reliable payers which can be used for further marketing by suppliers outside the organization.

The loyalty points can be presented by the loyalty server, optionally at fixed times, and sent to the telecommunication devices of the diverse subscribers which in that case must be in operation at that moment. A preferred embodiment of the telecommunication system according to the invention has in this respect the feature that the telecommunication device comprises a part of the telecommunication means in order to establish a connection with the server and to retrieve the points total from the server. The subscriber determines in this case himself whether and when contact will be made with the loyalty server to then download his possible loyalty points. Not only does this increase the efficiency of the data transfer, it also increases the involvement of the subscriber in the receipt of new loyalty points.

A particular preferred embodiment of the telecommunication system according to the invention has the feature that the telecommunication device comprises an interface for an intelligent chip card and that at least one part of the telecommunication means is arranged on a chip card. Owing to the application of a chip card and the arranging of at least a part of the communication electronics thereon, the architecture of the telecommunication device as such does not have to be modified, or hardly so, to the use in combination with the loyalty server. In a further preferred embodiment the telecommunication system according to the invention herein has the feature that a unique chip card is available for each subscriber and that the chip card contains all data required for this subscriber and electronics to retrieve the points total from the server and store it on the chip card via the telecommunication device. The verification and encryption keys possibly required for the communication as well as a unique access identification and password are in this case also stored on the chip card, so that the subscriber then has only to place the chip card in the interface intended for this purpose, whereafter the device will establish, maintain and subsequently close the telecommunication link, and the loyalty points are meanwhile transferred to the chip card. This contributes particularly toward convenience of use and the accessibility of the system to a wide clientele, while the user interface on the side of the communication device can also remain limited to the above stated chip card interface.

A further particular embodiment of the telecommunication system has the feature according to the invention that the telecommunication means are able to send the points total in combination with a unique transaction code. By sending a transaction code along with the points total and storing it together with the points total on the subscriber side, a later check is always possible on the transactions carried out on the subscriber side.

During a transfer of loyalty points from the server to the subscriber the transaction code can also be used as confirmation of receipt of the points, and is in that case sent back by the communication device after an error-free transfer.

Loyalty points can be linked to a time limit within which the equivalent value has to be utilized. To this end a further embodiment of the telecommunication system according to the invention has the feature that the server is able to log an expiry date with the points total, and that the expiry date is sent with the points total.

Not only the supplier of loyalty points directly involved in the system, such as the housing association in the above stated embodiment, but also third-party suppliers can be authorized to supply loyalty points to optionally selected subscribers. A supplier can thus decide for instance to give all “good” tenants a discount on a product or service supplied by this supplier, or even to supply a product or service free of charge so as to thus establish a new client contact. With a view to such an extension of the telecommunication system, the latter has the feature in a further embodiment according to the invention that the server is able to record a purchasing identification with the points total and that the purchasing identification is sent together with the points total. By means of the purchasing code it is always possible to verify whether or not a determined points total can be exchanged at a particular location for an equivalent value desired by the subscriber.

A further embodiment of the telecommunication system according to the invention is characterized in this latter respect in that the telecommunication device has at least temporarily available an electronically writable memory space per purchasing identification for the purpose of storing therein the points total per purchasing identification. By thus allocating separate memory spaces for the diverse suppliers of loyalty points, the purchasing identification can be used as access parameter for a specific memory domain, so that a loyalty points supplier does not have to be provided with access to the stored loyalty points of other suppliers.

An optionally specially developed personal computer provided with a modem or network adapter provides per se an outstanding platform on the subscriber side as telecommunication device within the telecommunication system according to the invention. Although the extent to which personal computers have penetrated has increased significantly, they are still by no means available in every household. In order to promote the introduction of the telecommunication system according to the invention in practice, it therefore has the feature in a particular embodiment that the telecommunication device comprises a telephone handset. Other than a personal computer, a telephone handset is now available in by far the majority of households, so that by making use thereof the telecommunication system according to the invention can extend to at least practically every household with a limited investment. Telephone handsets with the electronics required for the telecommunication system according to the invention and the intelligence to be able to establish contact with the loyalty server have in the meantime become commercially available, so that no additional development is required for this purpose.

A further embodiment of the telecommunication system according to the invention has the feature that the telecommunication means have a visual display and are provided with means to show a status message from the server on the visual display. The display screen can per se be of many different types, varying from for instance a passive, single-line LCD or LED display to for instance a graphically active LCD or plasma screen. This will in all cases provide the option of drawing the attention of the subscriber to the availability of loyalty points, which he can then download. However, more general advertizing messages can thus also be sent, selectively or otherwise, to the subscribers via the display screen in the telecommunication system according to the invention.

A further particular embodiment of the telecommunication system according to the invention is characterized in that at least a part of the points total can be spent as call credit for the telephone handset. This is a particularly direct equivalent of the savings balance and has the advantage that the loyalty points do not have to be stored in or at the telecommunication device of the subscriber but can be shared directly with a telephone exchange in the telecommunication system. The telecommunication device at the subscriber can therefore remain of relatively simple design.

For the communication between the loyalty server and the telecommunication device use can be made per se of any suitable network protocol. However, with a view to a smooth link-up of the telecommunication system to other networks, a particular embodiment of the telecommunication system according to the invention has the feature that the communication means are capable of communication on the basis of the TCP/IP transmission protocol. A further particular embodiment of the telecommunication system according to the invention more particularly has the feature that the network is the internet and that the telecommunication device is suitable for data exchange with the internet. In addition to the possibility of receiving loyalty points, every subscriber thus also has available a fully functional connection to the internet, with all of the ever-increasing possibilities this implies.

Irrespective of the network protocol used, the transfer of loyalty points can be carried out in different forms, for instance in the form of an optionally secured and coded data file. However, a further preferred embodiment of the telecommunication system has the feature according to the invention that the server is able to provide the points total in the form of a packet for electronic message traffic. A further embodiment of the telecommunication system according to the invention more particularly has the feature that a mail server is included therein which comprises a mailbox for electronic message traffic at least substantially per subscriber. It is thus possible to make use of commercially available software for electronic message traffic, so-called email, so that the implementation of the communication software within the telecommunication system according to the invention requires hardly any further development. Furthermore, each subscriber in the telecommunication system according to the invention thus has email facilities at his disposal, whereby he can also receive messages from third parties and can himself optionally send messages. By allocating a mailbox per subscriber the loyalty server can always place possible loyalty points messages in the mailbox of the subscriber, irrespective of whether his telecommunication device is operational, so that the server is no longer occupied with message traffic with the subscriber.

The invention also relates to a telecommunication device for application in the above described telecommunication system according to the invention, and will now be further elucidated with reference to an embodiment and an associated drawing. In the drawing:

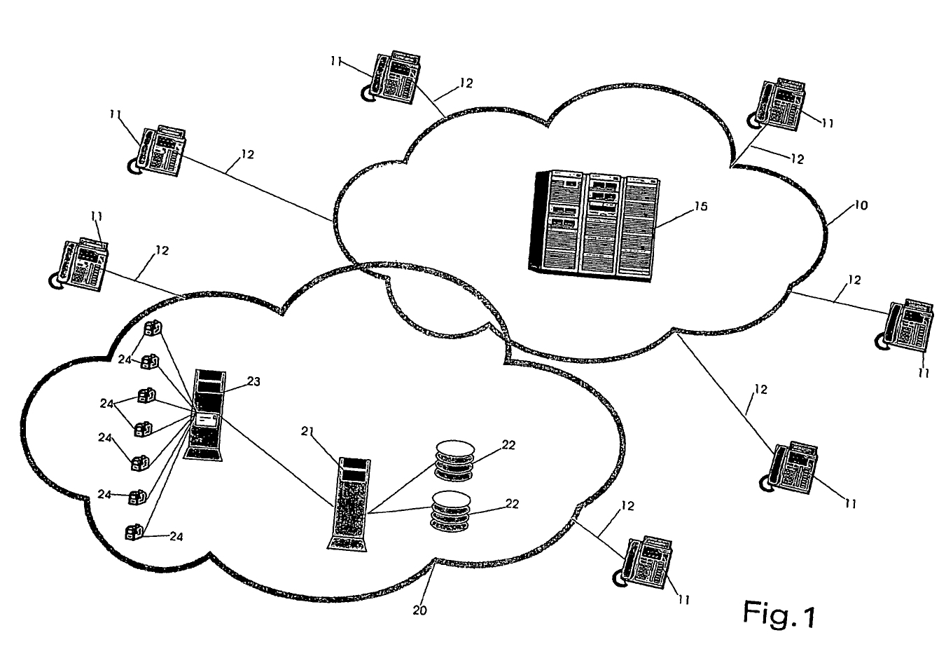

FIG. 1 shows a schematic view of an embodiment of a telecommunication system according to the invention.

In the embodiment of FIG. 1 use is made of a housing association which provides its tenants with the telecommunication system. Every tenant in principle becomes a subscriber herein of a telecommunication network 10 forming part of the provided telecommunication system. In this embodiment the telecommunication network 10 is a public telephone network to which the tenants/subscribers are connected via a telecommunication device 11 in the form of a telephone handset. This will usually take the form of wired connections 12 to the network which are shown schematically here by means of full lines, but it is also possible for the telecommunication system to extend over wireless network connections such as are made with mobile telephones, for instance on the basis of GSM or other standard employed now or in the future for wireless telephony and related telecommunication services. A suitable public telephone exchange 15 or system of exchanges provides the telephone service and possible related services between the different telephone handsets 11 mutually and to other networks.

For the operation within the telecommunication system according to the invention the telephone handsets must have the hardware and software necessary to enable communication with a loyalty server 21 which is coupled according to the invention to network 10. Such telephone handsets are however commercially available, for instance under the designation Smartphone and Cobrazzi, and do not therefore have to be developed, or at least not wholly. Such an intelligent telephone handset is made available by the housing association to the tenants and a chip card is also issued to each tenant which carries his unique personal data and on which loyalty points can be stored. The telephone handsets have the necessary hardware and software, including the necessary interface, to receive such a chip card and to communicate therewith.

The holder of such a chip card will regularly be eligible for loyalty points or bonus points from the housing association if he for instance pays his rent on time or maintains his home and his living environment with proper care. A good tenant is thus rewarded for his good tenant behaviour, which will stimulate him to continue therewith, and a database is also built up of reliable clients. The potential destination of the loyalty points is determined by the housing association, and can for instance entail a discount on a subsequent rent instalment or may be a balance which can be spent elsewhere, such as for instance a call credit for telephony in network 10, or a discount on a purchase at a shop or catering establishment selected for this purpose.

In addition to the housing association, other participants can also be involved in the telecommunication system according to the invention, particularly for instance sole traders, chain stores, retail chains such as department stores and supermarkets, (fast food) restaurants and shopping centres. All these participants, designated hereafter as partners, can be given the opportunity to offer loyalty points to the subscribers of the telecommunication system, wherein a selection is optionally made within the database of subscribers, for instance only those who pay their rent on time. The database with subscribers can thus be extensively exploited, wherein each participant can benefit; the housing association in the form of improved tenant behaviour, the partners in the form of a new, optionally selected circle of potential new customers, and the subscriber in the form of the loyalty points and the advantage these offer him.

For the implementation of the telecommunication system according to the invention a loyalty server 21 is coupled to network 10. The loyalty server forms part of a second network 20 which is operated on the basis of the generally applied TCP/IP network protocol and comprises a computer capable of managing one or more data files 22 in which the data of the tenants/subscribers is stored. These data files 22 are structured as relational database and are optionally stored on a local storage medium such as a hard disk unit of the loyalty server. It is also possible for the physical storage of the data to be accessible elsewhere in the second network 20. In the case of a malfunction in the loyalty server 21, all data is mirrored in the network, which means that in reality multiple servers are on stand-by for the case one of them fails, and that the data 22 is simultaneously available at different locations in network 20. For the second network use is made in this case of the internet, so that the infrastructure required for this purpose is already available.

Personal data for each subscriber is recorded in database 22 and loyalty points allotted to the relevant subscriber by the housing association or one of the partners can also be recorded therein per subscriber. Communication means are present in the telecommunication system to send the points total thus stored in the loyalty server to the telephone handset 11 of the subscriber. These means comprise in this embodiment a mail server 23 suitable for electronic message traffic on the basis of the so-called SMTP protocol. The mail server maintains for each subscriber a virtual mailbox 24 in which the messages intended for the relevant subscriber are placed in a queue. Because use is made of SMTP and of internet as the network 20 within which the loyalty server and the mail server are operated, with a relatively simple operation the mailboxes 24 can also be made available as public mailboxes for internet email, whereby the subscribers become full recipients of internet email. The subscribers themselves can designate an email address to which a domain held by the housing association is preferably coupled, for instance @home-online.LL, with LL as two-letter country code or com-extension.

As soon as new loyalty points are available for a subscriber, this information is stored as such by loyalty server 21 in database 22 and an electronic message to this effect is composed which is sent to mail server 23. The latter places this message in the relevant mailbox 24. The message which is sent has a defined format which includes, among other things:
the number of loyalty points,
an identification of the supplier,
an optional limited period of use,
an optional status message,
a unique transaction code, and
the points themselves which are placed in a coded form, wherein the encryption and decryption keys for the code are available only on the chip card of the relevant subscriber.

Periodically, for instance every evening, the intelligent telephone 11 of the subscriber automatically dials into the network 10,20 to empty the mailbox 24. The telephone has a display screen 13 on which the received electronic messages can then be read. In addition to advertising messages and personal email, there is the message that loyalty points are available. The verification and connection information required to collect these messages is located on the personal chip card of the user, from whom the only action expected is the insertion of the chip card in the interface of handset 11 intended for this purpose.

With the chip card inserted into the handset the subscriber can also download the loyalty points themselves. For this purpose he gives the relevant command from his handset 11, for instance by pressing a special function key. Handset 11 now makes automatic connection with the loyalty server which then sends the loyalty points in coded form to the handset, accompanied by the unique transaction code. This takes places message by message, wherein the status message included in the message appears in each case on the display screen of handset 11, for instance “these loyalty points are offered to you by”, followed by the name of the supplier, or “these loyalty points are offered to you because of”, followed by the reason for the loyalty points, such as for instance the exemplary tenant behaviour. The read message is now processed by handset 11 in combination with the chip card and the loyalty points are stored on the chip card. The chip card has for this purpose a number of sections of electronically writable and readable memory which, in accordance with the identification of the supplier of the loyalty points as shown in the message, are allocated in each case as purchasing identification. In the case of a partner in the telecommunication system only the part of the memory relevant to this partner can be read directly in each case, and other parts remain inaccessible. An optionally limited period of use, for instance in the form of a final date of use, is likewise indicated during loading on the display window of the handset. As soon as this time-limit has passed, the loyalty points will be automatically erased from the card. This can take place for instance by placing the chip card in the handset.

As soon as the loyalty points have been duly received by the chip card, a receipt message is sent by the handset to the loyalty server. This message contains the unique transaction code, which thus provides verification of the delivery of the loyalty points. After receipt thereof, the transaction is recorded as completed by the loyalty server. The unique transaction code is also recorded on the chip card until the card is topped up on a subsequent occasion. A subsequent, new unique transaction code is then registered on the card. This procedure is important in the case that a message is lost, for instance because the communication with the loyalty server is broken during the transaction. The transaction is in that case possibly registered by the server as not being completed. The next time loyalty points are added, the interrupted message will possibly be sent to the handset again, in which case however the message is recognized by the chip card on the basis of the transaction code stored on the chip card and is not processed again. A receipt confirmation in this respect is now sent once again to the loyalty server, so that the transaction can still be registered correctly.

The different partners of the telecommunication system each have available the telecommunication equipment necessary for reading the chip card of a subscriber and for deducting loyalty points therefrom in the case of a related purchase by the subscriber. This telecommunication equipment is also coupled to network 20 and to the loyalty server, so that this transaction can also be registered in the telecommunication system. If the loyalty points represent a call credit, this can even be exchanged directly with a billing system within the network 10,20 and coupled to telephone exchange 15.

The telecommunication system according to the invention thus opens a closed system within which new ways of modem sales and marketing are provided on the basis of a customer directory which is monitored and initiated by the suppliers.

Although the invention has been further elucidated with reference to only a single embodiment, it will be apparent that the invention is by no means limited to the given embodiment. On the contrary, many variations and embodiments are possible within the scope of the invention. The telecommunication system can thus be employed with similar benefit not only by a housing association but also by other suppliers of continuing performance contracts, such as telephony, utility companies, lenders such as finance companies and mortgage lenders, insurers and so on, to stimulate compliance with contractual obligations among their customers. In the case of insurers, bonus points could for instance also be issued periodically if no claim for damage has been submitted for a particular period, which may be an additional means of limiting the total sum paid out, particularly in the case of health insurance companies and nonlife insurance companies. Fully functional internet facilities can also be added to the telecommunication system, in which case the telecommunication devices on the subscriber side must have available a user interface adapted thereto such as a (qwerty) keyboard and a graphic screen together with the required (browser) software. For this purpose use can particularly be made of an internet environment developed specifically for use with telephones, such as the Wireless Access Protocol (WAP) which has recently been introduced.

1. Telecommunication system comprising a telecommunication network with a number of optionally permanent connections for subscribers who are connected to the network via an optionally permanent telecommunication connection, wherein a subscriber has access to at least one telecommunication service by means of a telecommunication device coupled to a connection, characterized in that the telecommunication device is moreover able to establish a connection with a loyalty server which is coupled to the network and which is able to manage a database in which a points total per subscriber is at least temporarily recorded, and that communication means are provided to send the points total to the telecommunication device of a subscriber.

2. Telecommunication system as claimed in claim 1, characterized in that the telecommunication device comprises a part of the telecommunication means in order to establish a connection with the server and to retrieve the points total from the server.

3. Telecommunication system as claimed in claim 2, characterized in that the telecommunication device comprises an interface for an intelligent chip card and that at least one part of the telecommunication means is arranged on a chip card.

4. Telecommunication system as claimed in claim 3, characterized in that a unique chip card is available for each subscriber and that the chip card contains all data required for this subscriber and electronics to retrieve the points total from the server via the telecommunication device and store it on the chip card.

5. Telecommunication system as claimed in claim 1, characterized in that the telecommunication means are able to send the points total in combination with a unique transaction code.

6. Telecommunication system as claimed in claim 1, characterized in that the server is able to log an expiry date with the points total, and that the expiry date is sent with the points total.

7. Telecommunication system as claimed in claim 1, characterized in that the server is able to record a purchasing identification with the points total and that the purchasing identification is sent with the points total.

8. Telecommunication system as claimed in claim 7, characterized in that the telecommunication device has at least temporarily available an electronically writable memory space per purchasing identification for the purpose of storing therein the points total per purchasing identification.

9. Telecommunication system as claimed in claim 1, characterized in that the telecommunication device comprises a telephone handset.

10. Telecommunication system as claimed in claim 9, characterized in that the telecommunication means have a visual display and are provided with means to show a status message from the server on the visual display.

11. Telecommunication system as claimed in claim 9, characterized in that at least a part of the points total can be spent as call credit for the telephone handset.

12. Telecommunication system as claimed in claim 1, characterized in that the communication means are capable of communication on the basis of the TCP/IP transmission protocol.

13. Telecommunication system as claimed in claim 12, characterized in that the network is the internet and that the telecommunication device is suitable for data exchange with the internet.

14. Telecommunication system as claimed in claim 12, characterized in that the server is able to provide the points total in the form of a packet for electronic message traffic.

15. Telecommunication system as claimed in claim 14, characterized in that a mail server is included therein which comprises a mailbox for electronic message traffic at least substantially per subscriber.

16. Telecommunication device for application in the telecommunication system as claimed in claim 1.
